(19) United States
(12) Patent Application Publication
(10) Pub. No.: US 2024/0160662 A1
(43) Pub. Date: May 16, 2024

(54) TEXT INPUT TO THREE-DIMENSIONAL (3D) IMAGES

(71) Applicant: Lemon Inc., Grand Cayman (KY)

(72) Inventors: Kin Chung Wong, Los Angeles, CA (US); Blake Garrett Fuselier, Los Angeles, CA (US); Jing Liu, Los Angeles, CA (US); Jeffrey Jia-Jun Chen, Los Angeles, CA (US); Celong Liu, Los Angeles, CA (US); Tiancheng Zhi, Los Angeles, CA (US)

(21) Appl. No.: 18/054,592

(22) Filed: Nov. 11, 2022

(51) Int. Cl. G06F 16/58; G06F 16/532; G06F 16/538; G06F 40/205; G06T 15/00

(52) U.S. Cl. CPC G06F 16/5866; G06F 16/532; G06F 16/538; G06F 40/205; G06T 15/00

(57) ABSTRACT

A graphics-specific search engine receives a search input from a user account for a media platform, determines a search query parsed from the input, and searches a graphics-specific database for existing images that correspond to the search query. An image generator generates new images that correspond to the search query when the search result does not exceed a predetermined number. A graphics display engine sends a plurality of the images to an instance of an account for a media platform.

### TECHNICAL FIELD

The embodiments described herein pertain generally to providing three-dimensional (3D) models to a media account based on a text input to a media platform.

### BACKGROUND

Text-to-image generation is implemented on a growing scale, based on both open-source and proprietary solutions. Image generators receive a natural language descriptor and produce an image that matches the input descriptor, as a result of the generators having been trained on both descriptors and images procured from various sources, including results procured from Internet search engines.

### SUMMARY

In one example embodiment, a media platform includes a graphics-specific search engine that receives a search input, determines a search query from the received search input, and searches a graphics-specific database for existing images that correspond to the search query. The media platform also includes an image generator that generates new images that correspond to the search query when the result of the search does not exceed the predetermined number, and a graphics display engine to send at least a plurality of the generated new images to an instance of an account for the media platform.

In accordance with at least one other example embodiment, a method for generating three-dimensional (3D) models includes receiving a search input, searching a database for 3D models that correspond to keywords corresponding to the search input, and displaying, for selection on an instance of the account for the multi-media platform, a plurality of 3D models that correspond to the searching. At least part of the displayed 3D models is generated based on the keywords, when a result of the searching is a number of existing 3D models that is less than a threshold value.

In accordance with at least one other example embodiment, a non-volatile computer-readable medium has computer-executable instructions stored thereon, and when the instructions are executed, the instructions cause one or more processors to perform operations that include receiving input; parsing a searchable parameter from the input; expanding the searchable parameter; searching a database for existing images that correspond to the expanded searchable parameter; displaying, for selection on an instance of a social media account, a predetermined number of existing images when the searching results in a number that is at least a threshold number; generating new images based on the expanded searchable parameter when the searching results in a number that is less than the threshold amount; and displaying, for selection on the social media account, a predetermined number of the generated new images.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a system in which text input to 3D models may be implemented, arranged in accordance with at least some embodiments described and recited herein;

FIG. 2 is a schematic depiction of a storage/database utilized in implementation of text input to 3D models, arranged in accordance with at least some embodiments described and recited herein;

FIG. 3 shows an example processing flow for implementation of text input to 3D models, in accordance with at least some embodiments described and recited herein;

FIG. 4 shows an illustrative computing embodiment, in which any of the processes and sub-processes of procuring 3D models based on text input may be implemented as executable instructions stored on a non-volatile computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described and recited herein, as well as illustrated in the drawings, may be arranged, substituted, combined, separated, and designed in a wide variety of different configurations, all of which are explicitly contemplated herein.

Additionally, portions of the present disclosure may be described herein in terms of functional block components and various processing steps. It should be appreciated that such functional blocks may be realized by any number of hardware and/or software components configured to perform the specified functions.

In the present description and recitation, the following terms may be used, in addition to their accepted meaning, as follows.

References are made herein to a learned or trained computer or processor-related technologies by which decisions and/or actions are autonomously made, in place of human intervention. Included in such technologies are software, i.e., algorithms and/or programs, hardware or firmware, or any combination thereof that supports machine learning, natural language understanding, natural language processing, speech recognition, computer vision, etc. Also included among the range of functions and capabilities, and pertinent to the embodiments disclosed, recited, and suggested herein, is image generation by which images or models are generated based on an input. 3D models are among the generated images contemplated by the non-limiting embodiments disclosed, recited, and suggested herein. The example embodiments also exploit text input, though it is well within the scope of such embodiments to exploit audio or image input.

Generated images may refer to latent representations of user or machine input to an enabling computer or processor. The generated images result from the enabling computer or processor having been trained on a plethora of images corresponding to input, whether text, audio, or image, retrieved from various sources including defined or general searches from various internet resources. In accordance with at least some embodiments, the generated images further result from at least a portion of the user or machine input being expanded, supplemented, or otherwise augmented with appropriately categorized descriptors.

Algorithms and programs for creating images, including 3D models, are known in the art; further, the aforementioned descriptors are matched or corresponded to the input, or a portion thereof, based on known learning techniques.

A social media application, as disclosed and recited herein, may refer to an on-line application that allows account-holding users to interact with one another using various media and on varying scales, with such interaction including creating and/or sharing media content. As disclosed and recited herein, a user device may have an instance of social media application account stored locally or may access the user's account via a web-based version of the particular social media application.

A platform, e.g., a social media platform, as disclosed and recited herein, may refer to an application on which algorithms and/or programs enabling execution or implementation of a collection of communication-based or media-sharing technologies may be hosted. Non-limiting examples of such technologies may include the creation, sharing, and/or storage of multi-media offerings.

Media, or multi-media, offerings or experiences, as referenced herein, may include but not be limited to recorded or live transmittable content including text, audio, images, animations, video, etc. In addition, such offerings or experiences may include, but again not be limited to, interactive augmented reality (AR) and/or interactive virtual reality (VR) experiences.

Augmented reality (AR), as referenced herein, may pertain to one or more interactive-reality-based display environments that exploit computer-generated display, sound, textual, and other sensory-driven effects to enhance a user's experience. AR integrates digital information into a user's real-world environment.

Virtual reality (VR), as referenced herein, may pertain to one or more interactive-reality-based display environments the exploit computer-generated display, sound, textual, and other sensory-driven effects to enable a user to experience and manipulate a surrounding environment as if in a real-world environment. VR provides sensory stimuli that, in combination with the user's physical actions, influence the corresponding digital environment.

An engine or generator, as disclosed, recited, and/or suggested herein, may refer to a type of software, firmware, hardware, or any combination thereof, that facilitates generation of source code or markup to produce elements that begin another process. In addition, or alternatively, an engine or generator may facilitate automated processes, in which various software elements interact to produce an intended product, whether physical or virtual. In accordance with known machine-learning technologies, the engines or generators disclosed, recited, and/or suggested herein are trained in accordance with either unimodal or multimodal training models.

3D (three-dimensional) images or models, as disclosed, recited and/or suggested herein, may refer to a single image or image model that may simultaneously incorporate multiple viewpoints. 3D imaging is known in the art.

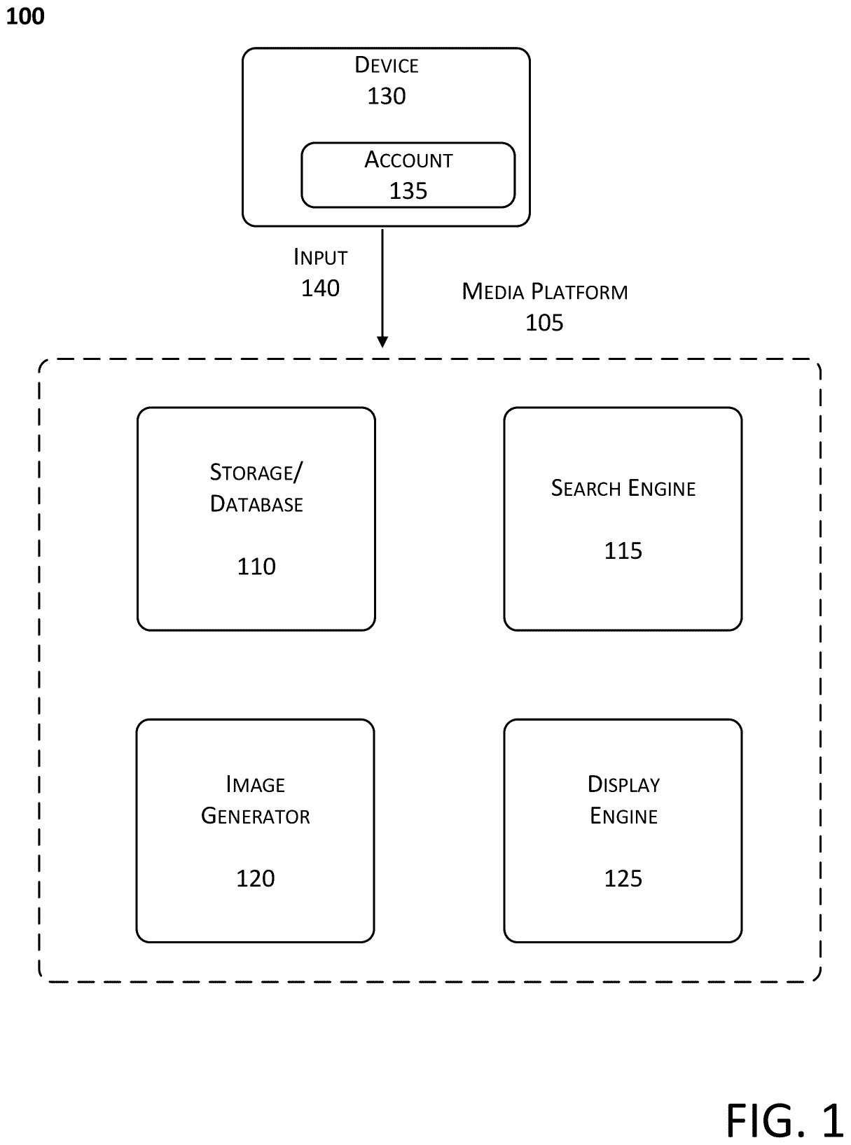

FIG. 1 shows a system in which input to 3D models may be implemented, arranged in accordance with at least some embodiments described and recited herein. As depicted, system 100 includes at least media platform 105, which includes at least storage/database 110, search engine 115, image generator 120, and display engine 125. System 100 further includes device 130, which may host or access an instance of user account 135 corresponding to media platform 105. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof.

Media platform 105 may refer to one or a cluster of servers on which are hosted one or more algorithms and/or programs that are designed, programmed, or otherwise configured to execute or implement various media-related technologies. Non-limiting example embodiments of media platform 105 are provided as a social media platform. Thus, media platform 105 may provide various services, including providing recorded or live-streaming content and interactive AR or VR experiences to account 135 hosted or accessed on device 130.

Storage/database 110 may refer to an algorithm, program, component, and/or module that is hosted on, or remotely and communicatively corresponds to, media platform 105. Storage/database 110 may be designed, programmed, or otherwise configured to receive and store queries and/or search terms corresponding to input 140, received at platform 105 from account 135.

Storage/database 110 and/or search engine 115 may be trained, designed, programmed, or otherwise configured to parse from input 140 one or more search parameters, e.g., keyword and/or pertinent physical feature. According to at least some embodiments, the parsed search parameter, i.e., keyword, serves as the basis for an image search. Further to such embodiments, the parsed search parameters may be categorized in accordance with known techniques and stored in storage/database 110.

Storage/database 110 may also be trained, designed, programmed, or otherwise configured to store and/or retrieve for display graphic images, e.g., 3D models that are generated by at least image generator 120, in accordance with the non-limiting example embodiments described and recited herein.

Search engine 115 may refer to an algorithm, program, component, and/or module that is hosted on, or remotely and communicatively corresponds to, media platform 105. Search engine 115 may be trained, designed, programmed, or otherwise configured to receive input 140 from account 135 and search the contents of storage/database 110 for content, e.g., 3D models, that matches or otherwise corresponds to at least one search parameter that is parsed from input 140 from account 135. The input may be received directly from input 140 or, in accordance with at least some embodiments, received from storage/database 110.

In accordance with at least some of the non-limiting example embodiments described, recited and suggested herein, search engine 115 and/or storage/database 110 is further trained, designed, programmed, or otherwise configured to augment, supplement, or otherwise expand at least one search parameter that is parsed from input 140 received from account 135 with appropriately categorized descriptors. Thus, search engine 115 and/or storage/database 110 is able to expand upon a range of stored content to be searched and/or retrieved for display.

Image generator 120 may refer to a trained algorithm, program, component, and/or module that is hosted on, or remotely and communicatively corresponds to, media platform 105. Image generator 120 may be designed, programmed, or otherwise configured to newly generate images that correspond to the at least one search parameter that is parsed from input 140 received from account 135. According to various embodiments disclosed, recited, and suggested herein, image generator 120 may receive the parsed search parameter that has been augmented, supplemented, or otherwise expanded from storage/database 110 prior to generating new images.

That is, based on known iterative training techniques, storage/database 110 is populated with, and stores, categories of queries and/or search terms, as well as with libraries of corresponding descriptors for the respective queries/terms. Thus, as a keyword or other parameter is parsed from input 140, and the corresponding descriptors are attached or otherwise appended thereto, image generator 120 newly generate images that match or correspond to the augmented, supplemented, or otherwise expanded query/term. The generating of new images, in accordance with at least some of the embodiments, is executed or performed when a result of the search of storage/database 110 is less than a threshold number, e.g., 30, of matching or otherwise corresponding existing images based on either input 140 or the augmented, supplemented, or otherwise expanded query/term.

Display engine 125 may refer to a trained algorithm, program, component, and/or module that is hosted on, or remotely and communicatively corresponds to, media platform 105. Display engine 125 may be designed, programmed, or otherwise configured to execute instructions to display content retrieved from storage/database 110 when a number of existing images that match or otherwise correspond to at least portions of input 140 received from account 135 or the query/term that has been augmented, supplemented, or otherwise expanded is equal to or greater than a threshold value, e.g., 30. The scale of the threshold value may be dynamic depending on user context, user preferences, display capabilities, local storage capacity, etc. In addition, or alternatively, display engine 125 may be designed, programmed, or otherwise configured to execute instructions to display content generated by image generator 120.

Device 130 may refer to one or more embodiments of a classical computing environment that may be, or include, a classical computer, processing device, a microprocessor, a microcontroller, a digital signal processor, or any combination thereof, on which account 135 or an instance thereof is assembled, managed, compiled, and/or executed. Device 130 may be one of various electronic devices, or a combination thereof, having one or more display screens with audio and/or video inputs/outputs and that supports the providing of and consumption of content relative to media platform 105. The various electronic devices may include but not be limited to a smartphone, a tablet computer, a laptop computer, a desktop computer, an e-book reader, an MP3 (moving picture experts group audio layer III) player, an MP4, and/or any other suitable electronic devices.

Any one or more of the server or cluster of servers upon which media platform 105 is hosted, as well as device 130, may refer to a high-performance computing (HPC) environment that includes, at least, a CPU and GPU that is present on a, e.g., a video card, embedded on a motherboard, or on the CPU die. The conversion of, e.g., text, input to 3D models, as disclosed and recited herein, may be executed entirely on the CPU or in part on the CPU and the GPU. Alternative embodiments may be executed in evolved HPC components known in the art. Regardless, the CPU, GPU, and/or HPC components may store one or more algorithms and/or programs that, when executed thereon, may cause the execution or performance of operations and/or functionality as disclosed and/or recited herein. In addition, a computer-readable non-volatile medium may be provided according to the embodiments described herein. The computer readable medium stores computer programs. The computer programs, when being executed by a processor, are used to execute or perform the operations or functionality in connection with at least the embodiments described and recited herein.

Input 140, in accordance with at least some of the embodiments disclosed and recited herein, may refer to text, audio, or image input manually or in an automated manner to an appropriate input interface corresponding to the instance of account 135. Input 140 may be transmitted or otherwise communicated to a receiving component corresponding to media platform 105 via a wired or wireless network. Such network may be regarded as a medium that is provided as a bidirectional communications link between media platform 105 and device 130. The network may include the Internet, a local area network (LAN), a wide area network (WAN), a local interconnect network (LIN), a localized cloud, etc.

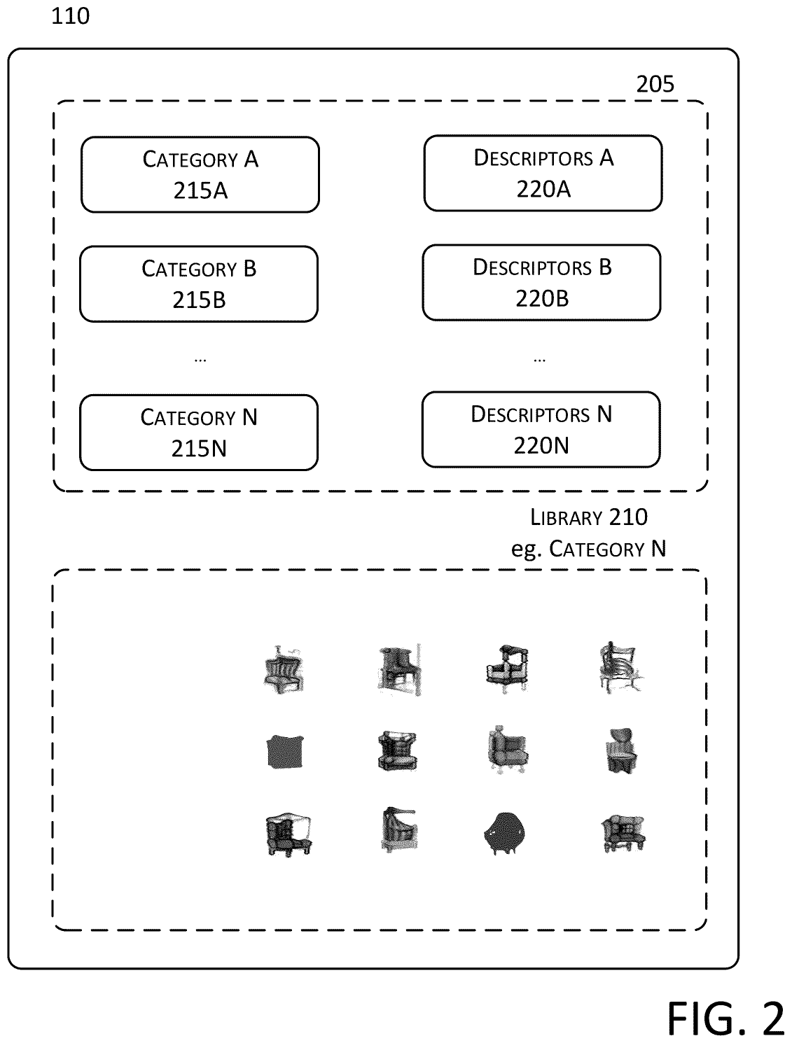

FIG. 2 is a schematic depiction of storage/database 110 utilized in implementation of input to 3D models, arranged in accordance with at least some embodiments described and recited herein. As depicted, storage/database 110 includes at least query library 205 and image library 210. Query library 205, which includes category sub-libraries 215A-215N and corresponding descriptor sub-libraries 220A-220N. It will be understood by those skilled in the art that the quantity of libraries and sub-libraries referenced herein are not limited to those depicted in the figure, as “N” is intended to connote an unbounded quantity. Further, unless context dictates otherwise, reference may be made to “category library 215” and/or “descriptor library 220,” in the singular or plural, without excluding any of the other instances thereof. It will also be understood that each storage function and/or operation of the various libraries or storage components may be implemented, individually and/or collectively, by a wide range of hardware, software, firmware, or any combination thereof.

Query library 205 may be designed, configured, or otherwise programmed to receive and/or input 140, either intact, parsed, or augmented, supplemented, or otherwise expanded. If the augmenting, supplementing, or expanding of a parsed search parameter is executed on storage/database 110, the expanded parameter is assigned to or otherwise stored in one of category libraries 215 based on known training techniques.

Query library 205 may also be designed, configured, or otherwise programmed to augment, supplement, or otherwise expand the categorized parsed search parameters with descriptors from an appropriately corresponding one of libraries 220.

Library 210 may refer to one or plural sub-libraries that receive and/or store images that are subjected to search by search engine 115. The descriptors may be retrieved from various sources, including results of one or more internet search engines.

In accordance with a non-limiting example, if input 140 is “armchair furniture,” search engine 115 and/or storage/database 110, either singularly or in combination, may parse “armchair” from input 140, which, as an example, corresponds to Category N 215N; and augment, supplement, or otherwise expand “armchair” with Descriptors N in sub-library 220N. Thus, search engine 115 and/or storage/database 110 is able to expand upon a range of stored content in library 210, which stores, e.g., 3D models of armchairs. Non-limiting examples of the expanded query/search terms may include, “purple armchair,” “oakwood armchair,” “60's style armchair,” contemporary style armchair,” etc. Search engine may then search a corresponding portion of library 210, or sub-library 210N, for matching or otherwise corresponding images for an expanded query/search term. The present example is not limiting. For example, if input 140 is “armchair furniture,” search engine 115 and/or storage/database 110 may alternatively parse “furniture” from input “140,” which may correspond to another one of Categories A through N. Further, with regard to either non-limiting example embodiment, the parsed search term may correspond to multiple ones of Categories A through N.

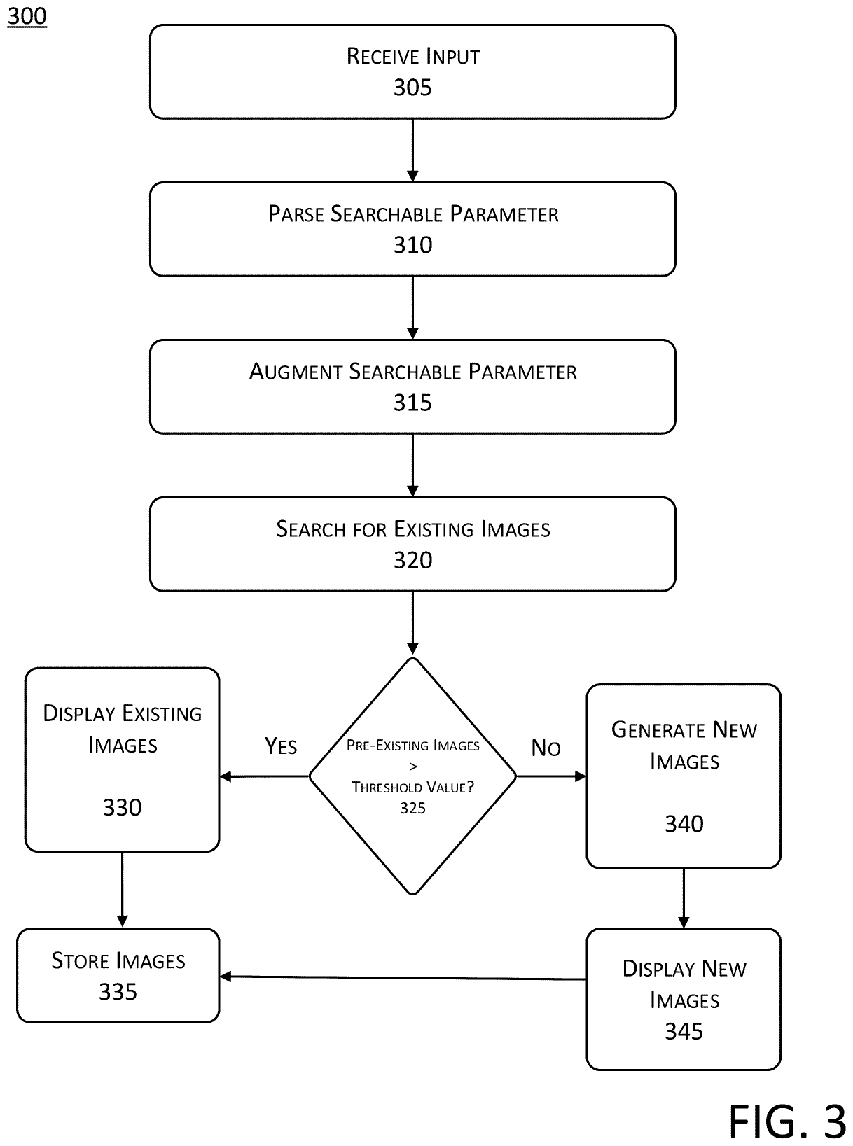

FIG. 3 shows an example processing flow for implementation of input to 3D models, in accordance with at least some embodiments described and recited herein. As depicted, processing flow 300 includes sub-processes executed by various components of system 100 including media platform 105. However, processing flow 300 is not limited to such components and processes, as obvious modifications may be made by re-ordering two or more of the sub-processes described here, eliminating at least one of the sub-processes, adding further sub-processes, substituting components, or even having various components assuming sub-processing roles accorded to other components in the following description.

In accordance with at least non-limiting example embodiment of processing for implementation of input to 3D models, various components or modules of FIGS. 1 and 2 are trained, designed, programmed or otherwise configured to receive a text search input from an instance of an account for a multi-media platform, augment a keyword from the received text search input, search a database for existing three-dimensional (3D) models that correspond to the augmented keyword, and display for selection on the instance of the account for the multi-media platform a plurality of existing 3D models that correspond to the augmented keyword.

In accordance with at least one other non-limiting example embodiment, various components or modules of FIGS. 1 and 2 are trained, designed, programmed or otherwise configured to receive input from user interface for a social media account, parse at least one searchable parameter from the received input, augment the at least one searchable parameter, search a database for existing images that corresponds to the augmented at least one searchable parameter, display for selection on the social media account, a predetermined number of existing images when the searching results in a number of the existing images that is at least a threshold number; additionally or alternatively, generate new images based on the augmented at least one searchable parameter when the searching results in a number of existing images that is less than the threshold amount, and display for selection on the social media account a predetermined number, e.g., 15, of the generated new images.

Processing flow 300 may include various operations, functions, or actions as illustrated by one or more of blocks 305, 310, 315, 320, 325, 330, 335, 340, and 345. These various operations, functions, or actions may, for example, correspond to software, program code, or program instructions executable by a digital processor that causes the functions to be performed. Processing may begin at block 305.

At block 305 (receive input), storage/database 110 and/or search engine 115 receive and/or store input 140 from account 135. Processing may proceed to block 310.

At block 310 (parse searchable parameter), storage/database 110 and/or search engine 115 parse from the received input one or more search parameters, e.g., keyword and/or pertinent physical feature. The parsed search parameter, i.e., keyword, may serve as the basis for an image search and then be categorized in accordance with known techniques and stored in an appropriate one of libraries 215. Processing may proceed to block 315.

At block 315 (augment searchable parameter), storage/database 110 and/or search engine 115 augment, supplement, or otherwise expand the parsed search parameter with appropriately categorized descriptors stored on storage/database 110. Processing may proceed to block 320.

At block 320 (search for existing images), search engine 115 searches for existing images, e.g., 3D models stored on storage/database 110, that match or otherwise correspond to the expanded search parameter. Processing may proceed to decision block 325.

At decision block 325 (pre-existing images>threshold value), search engine 115 may determine whether a number of existing images, e.g., 3D models stored on storage/database 110, that match or otherwise correspond to the expanded search parameter exceeds a threshold value. The scale of the threshold value is dynamic depending on user context, user preferences, display capabilities, local storage capacity, etc. If the determination at decision block 325 is “yes,” processing may proceed to block 330; but if the determination at decision block 325 is “no,” processing may proceed to block 340.

At block 330 (display existing images), display engine 125 displays content retrieved from storage/database 110 for viewing and/or selection by a user corresponding to account 135. The retrieved content is displayed when a number of existing images that match or otherwise correspond to the expanded search parameter is equal to or greater than the threshold value. In accordance with at least some of the example embodiments, the existing images are displayed based on popularity or favorability rankings as determined by previous usage or selection by a community of user accounts 135 that also have access to content on storage/database 110. The popularity or favorability within the aforementioned community may pertain to the images that are utilized most often in published videos on the platform. Processing may proceed to block 335.

At block 335 (store images), upon display and/or selection or usage by account 135, the displayed images are stored again in storage/database 110, set to be retrievable in order of ranking or favorability. An order or sequence of the storage of the images corresponds to the popularity or favorability rankings of the images, which may be based upon selections made during execution at block 330.

At block 340 (generate new images), image generator 120 generates new images that correspond to the expanded search parameter received from storage/database 110.

According to some of the non-limiting example embodiments, block 340 is executed when the determination at decision block 325 is “no.” However, in accordance with some alternative embodiments, block 340 may be executed serially or sequentially to block 330 being executed. Regardless, processing may proceed to block 345.

At block 345 (display new images), display engine 125 displays content newly generated by image generator 120. Processing may proceed to block 335.

At block 335 (store images), upon display and/or selection or usage of the newly generated images by account 135, the new images are stored in storage/database 110. An order or sequence of the storage of the images corresponds to the popularity or favorability rankings of the images based upon selections made during execution at block 340. Again, popularity or favorability by others within the aforementioned community may pertain to the images that are utilized most often in published videos on the platform.

Once existing and/or newly generated images are stored, in accordance with block 335, the existing images may be subsequently displayed based on popularity or favorability rankings based on previous usage or selection by a community of user accounts 135 that also have access to content on storage/database 110.

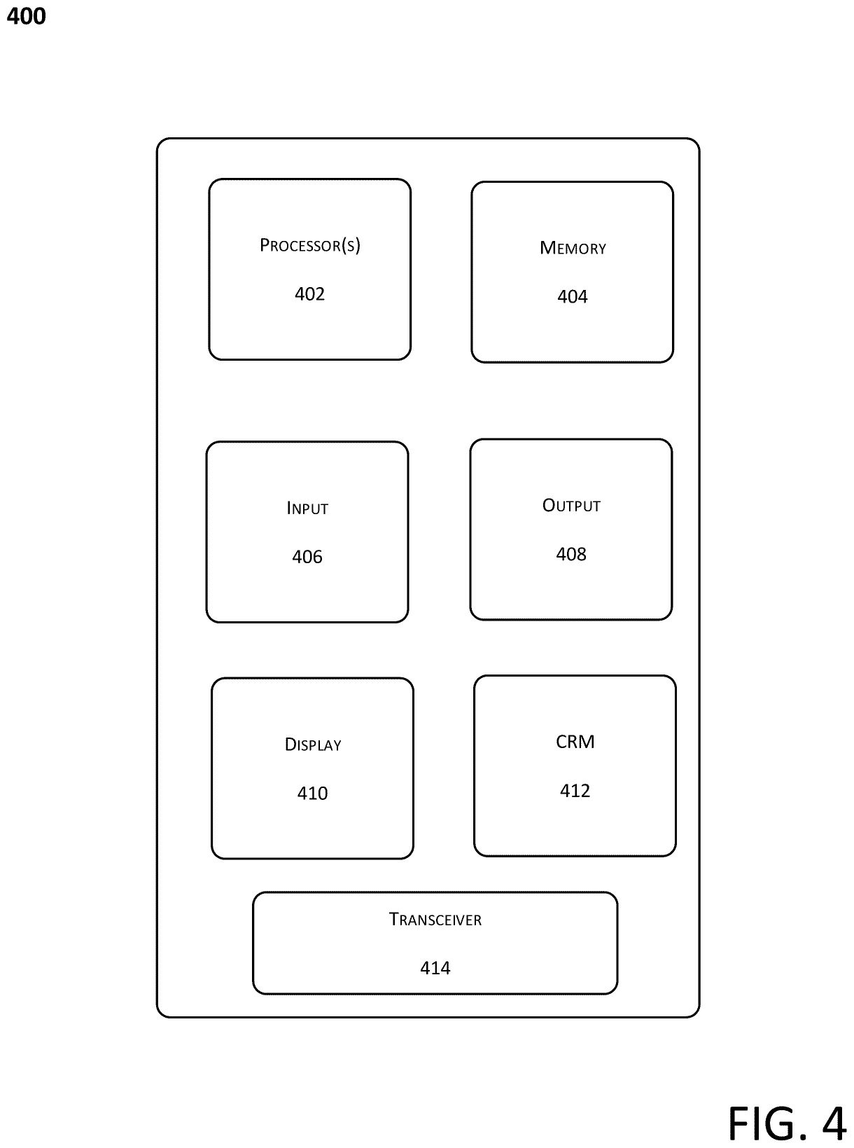

FIG. 4 shows an illustrative computing embodiment, in which any of the processes and sub-processes of procuring 3D models based on text input may be implemented as executable instructions stored on a non-volatile computer-readable medium. The computer-readable instructions may, for example, be executed by a processor of a device, as referenced herein, having a network element and/or any other device corresponding thereto, particularly as applicable to the applications and/or programs described above corresponding to system 100 procuring 3D models based on text input.

In a very basic configuration, a computing device 400 may typically include, at least, one or more processors 402, a memory 404, one or more input components 406, one or more output components 408, a display component 410, a computer-readable medium 412, and a transceiver 414.

Processor 402 may refer to, e.g., a microprocessor, a microcontroller, a digital signal processor, or any combination thereof.

Memory 404 may refer to, e.g., a volatile memory, non-volatile memory, or any combination thereof. Memory 404 may store, therein, an operating system, one or more applications corresponding to media platform 105 and/or program data therefore. That is, memory 404 may store executable instructions to implement any of the functions or operations described above and, therefore, memory 404 may be regarded as a computer-readable medium.

Input component 406 may refer to a built-in or communicatively coupled keyboard, touch screen, or telecommunication device. Alternatively, input component 406 may include a microphone that is configured, in cooperation with a voice-recognition program that may be stored in memory 404, to receive voice commands from a user of computing device 400. Further, input component 406, if not built-in to computing device 400, may be communicatively coupled thereto via short-range communication protocols including, but not limitation, radio frequency or Bluetooth®.

Output component 408 may refer to a component or module, built-in or removable from computing device 400, that is configured to output commands and data to an external device.

Display component 410 may refer to, e.g., a solid state display that may have touch input capabilities. That is, display component 410 may include capabilities that may be shared with or replace those of input component 406.

Computer-readable medium 412 may refer to a separable machine-readable medium that is configured to store one or more programs that embody any of the functions or operations described above. That is, computer-readable medium 412, which may be received into or otherwise connected to a drive component of computing device 400, may store executable instructions to implement any of the functions or operations described above. These instructions may be complimentary or otherwise independent of those stored by memory 404.

Transceiver 414 may refer to a network communication link for computing device 400, configured as a wired network or direct-wired connection. Alternatively, transceiver 414 may be configured as a wireless connection, e.g., radio frequency (RF), infrared, Bluetooth®, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

### ASPECTS

Aspect 1. A media platform, comprising:
a graphics-specific search engine to:
   receive a search input,
   determine a search query from the received search input, and
   search a graphics-specific database for existing images that correspond to the expanded search query;
an image generator to generate new images that correspond to the search query when the result of the search does not exceed the predetermined number; and
a graphics display engine to send at least a plurality of the generated new images to an instance of an account for the media platform.

Aspect 2. The media platform of Aspect 1, wherein the graphics display engine is to further send at least some of the existing images to the instance of the account for the media platform.

Aspect 3. The media platform of either of Aspect 1 or Aspect 2, wherein the image generator is a three dimensional (3D) image generator.

Aspect 4. The media platform of any of Aspects 1-3, wherein the existing images and the new images are stored in a storage system for usage and ranking by popularity.

Aspect 5. The media platform of any of Aspects 1-4, wherein the search query is expanded.

Aspect 6. A method of generating three-dimensional (3D) models, comprising:
receiving a text search input;
searching a database for 3D models that correspond to keywords corresponding to the expanded search input; and
displaying, for selection on an instance of the account for the multi-media platform, a plurality of existing 3D models that correspond to the expanded keyword;
wherein, at least some of the displayed 3D models are generated based on the keywords, when a result of the searching is a number of existing 3D models that is less than a threshold value.

Aspect 7. The method of Aspect 6, wherein the search input is in text form, and the keywords are expanded from the received text search input.

Aspect 8. The method of either Aspect 6 or Aspect 7, wherein the multi-media platform is a social media platform.

Aspect 9. The method of any of Aspects 6-8, wherein the multi-media platform is a virtual reality (VR) platform.

Aspect 10. The method of any of Aspects 6-9, wherein the 3D models are generated by an image generator.

Aspect 11. The method of any of Aspects 6-10, wherein, when a result of the searching is a number of existing 3D models that is less than a threshold value, the method further comprises:
transmitting the expanded keyword to the image generator; and
displaying the 3D models including the existing images and the generated new images.

Aspect 12. The method of any of Aspects 6-11, wherein the displaying of the 3D models are ranking by matching property and popularity.

Aspect 13. The method of any of Aspects 6-12, wherein the displaying of existing 3D models and the displaying of new 3D models is on a social media platform.

Aspect 14. The method of any of Aspects 6-12, wherein the displaying of existing 3D models and the displaying of new 3D models is on a VR media platform.

Aspect 15. A non-volatile computer-readable medium having computer-executable instructions stored thereon that, upon execution, cause one or more processors to perform operations comprising:
receiving input;
parsing at least one searchable parameter from the received input;
expanding the at least one searchable parameter;
searching a database for existing images that correspond to the expanded at least one searchable parameter;
displaying, for selection on an instance of a social media account, a predetermined number of existing images when the searching results in a number of the existing images that is at least a threshold number;
generating new images based on the expanded at least one searchable parameter when the searching results in a number of existing images that is less than the threshold amount; and
displaying, for selection on the social media account, a predetermined number of the generated new images.

Aspect 16. The computer-readable medium of Aspect 15, wherein the received input is a text input.

Aspect 17. The computer-readable medium of Aspect 15, wherein the received input is in audio format.

Aspect 18. The computer-readable medium of any of Aspects 15-17, wherein the database stores the existing images and the new images for usage and ranking by other accounts on a same platform as the social media account.

Aspect 19. The computer-readable medium of any of Aspects 15-18, wherein the existing images and the generated new images are 3D models generated by an image generator.

Aspect 20. The computer-readable medium of any of Aspects 15-19, wherein the predetermined number of existing images are displayed in accordance with a ranking protocol.

Aspect 21. The computer-readable medium of Aspect 20, wherein the ranking protocol is based on a number of usages for respective ones of the existing images by at least some of the other accounts on the same platform as the social media account.

What is claimed:

1. A media platform, comprising:
a graphics-specific search engine to:
receive a search input,
determine a search query from the received search input,
search a graphics-specific database for existing images that correspond to the search query;
an image generator to generate new images that correspond to the search query when the result of the search does not exceed the predetermined number; and
a graphics display engine to send at least a plurality of the generated new images to an instance of an account for the media platform.

2. The media platform of claim 1, wherein the graphics display engine is to further send at least some of the existing images to the instance of the account for the media platform.

3. The media platform of claim 1, wherein the image generator is a three-dimensional (3D) image generator.

4. The media platform of claim 1, wherein the existing images and the new images are stored in a storage system for usage and ranking by popularity.

5. The media platform of claim 1, wherein the search query is expanded.

6. A method for generating three-dimensional (3D) models, comprising:
receiving a search input;
searching a database for 3D models that correspond to keywords corresponding to the search input; and
displaying, for selection on an instance of the account for the multi-media platform, a plurality of 3D models that correspond to the searching;
wherein, at least some of the displayed 3D models are generated based on the keywords, when a result of the searching is a number of existing 3D models that is less than a threshold value.

7. The method of claim 6, wherein the search input is in text form, and the keywords are expanded from the received text search input.

8. The method of claim 6, wherein the multi-media platform is a social media platform.

9. The method of claim 6, wherein the multi-media platform is a virtual reality (VR) medium platform.

10. The method of claim 6, wherein the 3D models are generated by an image generator.

11. The method of claim 10, wherein, when a result of the searching is a number of existing 3D models that is less than a threshold value, the method further comprises:
transmitting the keywords to the image generator; and
displaying the 3D models including the existing images and the generated new images.

12. The method of claim 11, wherein the displaying of the 3D models are ranking by matching property and popularity.

13. The method of claim 11, wherein the displaying of existing 3D models and the displaying of new 3D models is on a social media platform.

14. The method of claim 11, wherein the displaying of existing 3D models and the displaying of new 3D models is on a VR media platform.

15. A non-volatile computer-readable medium having computer-executable instructions stored thereon that, upon execution, cause one or more processors to perform operations comprising:
receiving input;
parsing at least one searchable parameter from the received input;
expanding the at least one searchable parameter;
searching a database for existing images that correspond to the expanded at least one searchable parameter;
displaying, for selection on an instance of a social media account, a predetermined number of existing images when the searching results in a number of the existing images that is at least a threshold number;
generating new images based on the expanded at least one searchable parameter when the searching results in a number of existing images that is less than the threshold amount; and
displaying, for selection on the social media account, a predetermined number of the generated new images.

16. The computer-readable medium of claim 15, wherein the received input is a text input.

17. The computer-readable medium of claim 15, wherein the database stores the existing images and the new images for usage and ranking by other accounts on a same platform as the social media account.

18. The computer-readable medium of claim 17, wherein the existing images and the generated new images are 3D models generated by an image generator.

19. The computer-readable medium of claim 17, wherein the predetermined number of existing images are displayed in accordance with a ranking protocol.

20. The computer-readable medium of claim 19, wherein the ranking protocol is based on a number of usages for respective ones of the existing images by at least some of the other accounts on the same platform as the social media account.
